(19) United States
(12) Patent Application Publication
(10) Pub. No.: US 2017/0011678 A1
(43) Pub. Date: Jan. 12, 2017

(54) DISPLAY DEVICE, TELEVISION SET AND CONTROL METHOD THEREOF

(71) Applicants: BOE TECHNOLOGY GROUP CO., LTD., Beijing (CN); BEIJING BOE MULTIMEDIA TECHNOLOGY CO., LTD., Beijing (CN)

(72) Inventors: Qinqin CAO, Beijing (CN); Wanli XU, Beijing (CN)

(21) Appl. No.: 15/099,127

(22) Filed: Apr. 14, 2016

(30) Foreign Application Priority Data
Jul. 10, 2015 (CN) 201510406014.8

(51) Int. Cl. G09G 3/20

(52) U.S. Cl. CPC G09G 3/2003; G09G 2320/0626; G09G 2360/144

(57) ABSTRACT

A display device, a television set and a control method thereof. The display device includes a display device body and a light detecting device fixed to the display device body. The light detecting device is configured to detect ambient brightness and send information on the ambient brightness to the display device body. The display device body is configured to compare a preset threshold value with the information on the ambient brightness and then adjust a display mode of the display device.

### TECHNICAL FIELD

Embodiments of the present disclosure relate to a display device, a television set and a control method thereof.

### BACKGROUND

At present, television sets are not only applied in daytime or with lights on, but also at night or in the dark. It is well known that eyes are susceptible to weariness or even injured after watching a liquid crystal display product for a long time, especially at night or in a dark situation. Generally, a display mode of a television set is adjusted according to specific time in a day. This method has some limitations, such as failing to adjust the display mode of the television set according to a variation of ambient light in a gloomy or a bad weather, which leads to poor user experience, etc.

### SUMMARY

In one aspect, an embodiment of the disclosure provides a display device, comprising a display device body and a light detecting device fixed to the display device body; the light detecting device is configured to detect ambient brightness and send information on the ambient brightness to the display device body, and the display device body is configured to compare a first preset threshold value with the information on the ambient brightness and adjust a display mode of the display device to be first display mode.

On another aspect, an embodiment of the disclosure provides a television set comprising the display device; the display device comprises a display device body and a light detecting device fixed to the display device body; the light detecting device is configured to detect ambient brightness and send information on the ambient brightness to the display device body, and the display device body is configured to compare a first preset threshold value with the information on the ambient brightness and adjust a display mode of the display device to be a first display mode.

On still another aspect, an embodiment of the disclosure provides a control method for a display device, comprising: monitoring brightness of ambient light; comparing the brightness of the ambient light with a first preset threshold value; and adjusting a display mode of the display device to be a first display mode if a brightness value of the ambient light is lower than the first preset threshold value.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic diagram of a display device according to an embodiment of the disclosure;

FIG. 2 is a flowchart illustrating an adjustment of the display device shown in FIG. 1;

FIG. 3 is a schematic diagram illustrating a correspondence relationship between brightness and voltage; and

FIG. 4 is a flowchart of a method for adjusting the display device shown in FIG. 1.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Embodiments of the disclosure provide a display device for adjusting a display mode automatically, a television set and a control method thereof. A display mode of the display device may be selected to be a daytime mode when a user is watching with sufficient light; the display mode of the display device may be selected to be a night mode when the user is watching in dark. The display mode and a brightness of backlight may be adjusted according to a change of ambient light detected by a light detecting device. The embodiments of the disclosure protect users' eyes, so that the users can watch TV at any time without eye fatigue. Eye fatigue and eye damages in dark may be reduced as much as possible by changing the brightness of the backlight as well as the display mode of the TV. It not only reduces the user's error operations, but also improves the user experience.

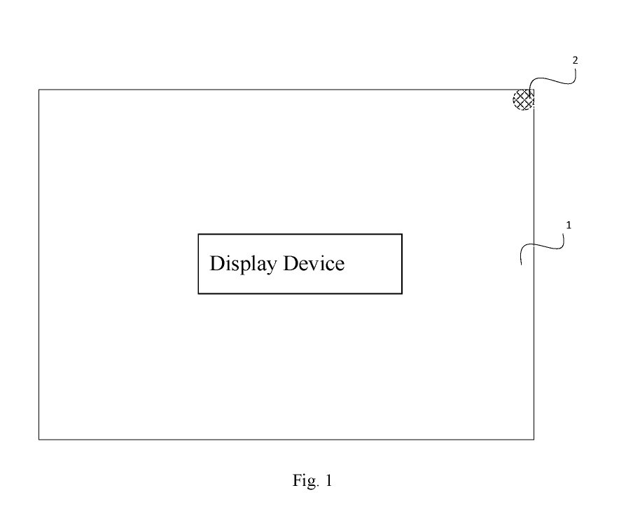

As shown in FIG. 1, an embodiment of the disclosure provides a display device for adjusting a display mode automatically. The display device includes a display device body 1 and a light detecting device 2 fixed to the display device body 1. The light detecting device 2 is configured to detect ambient brightness in real time, and send information on the ambient brightness to the display device body 1. The display device body 1 is configured to compare a preset threshold value with the information on the ambient brightness, and then adjusts a display mode of the display device. The display device provided by the embodiment of the disclosure will be further described in details below.

In order to improve detecting sensitivity to light, the light detecting device 2 is disposed behind a front glass plane. The light detecting device 2 may be located, for example, at a corner (e.g. the top right corner or the top left corner) of the front glass plane of the display device 1 to prevent the light detecting device 2 from influencing existing circuit structures or appearance of the display device 2. The light detecting device 2 detects ambient brightness in real time and sends information on the ambient brightness to the display device body 1. For example, a detecting period of the light detecting device 2 is less than 10 seconds or less than 5 seconds. The detecting period being short may facilitate a rapid adjustment. The display device body 1 compares a preset threshold value with the information on the ambient brightness, and then adjusts the display mode of the display device. For example, the display device body 1 includes a memory and a processor, the memory may store the preset threshold, and the processor may be configured to adjust the display mode of the display device. For example, the light detecting device 2 is a light sensor. The display device provided by the embodiment of the disclosure may adjust the display mode manually or automatically on demands.

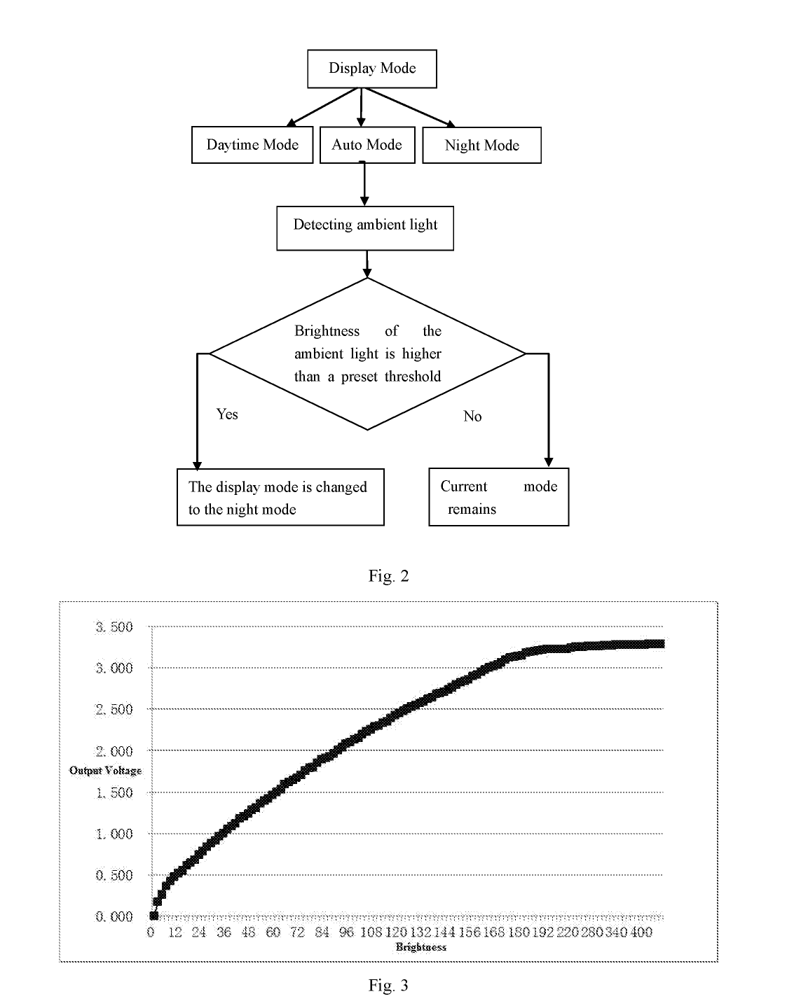

As shown in FIG. 2, the display device for adjusting the display mode automatically provided by the embodiment of the disclosure operates in such a process that the display mode of the display device may be manually selected to be a daytime mode when a user watches the display device with sufficient light, or as a night mode when the user watches in dark. The ambient light may be detected in real time by the light detecting device 2, so that the display mode and the backlight brightness of the display device 1 may be changed according to the ambient light. For example, when a brightness value of the ambient light detected by the light detecting device 2 is lower than a first preset threshold value that is preset, the current display mode of the display device is adjusted to be the night mode. When the brightness value of the ambient light detected by the light detecting device 2 is higher than a second preset threshold value that is preset, the current display mode of the display device is adjusted to be a daytime mode.

An embodiment of the disclosure further provides a television set using the display device described above. The television set may adjust a display mode manually or automatically in the same way as in the display device described above, therefore description thereof will be omitted herein.

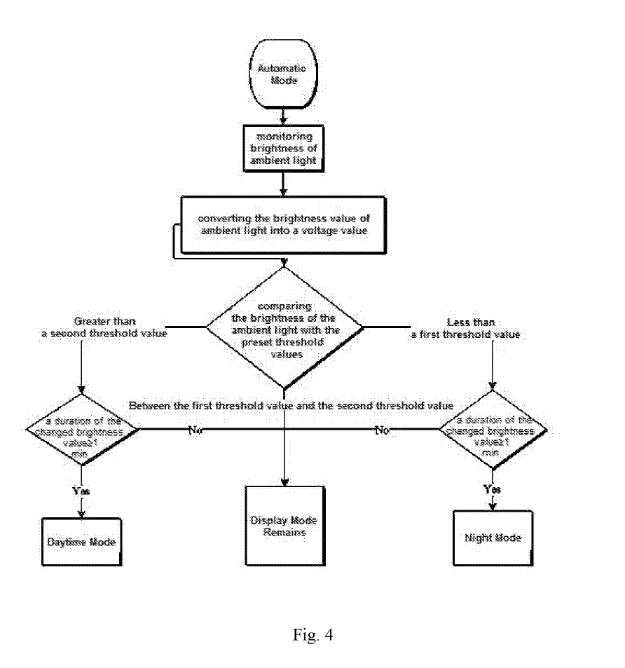

As shown in FIG. 4, an embodiment of the disclosure further provides a control method for the adjustment in the display device described above. The method for adjusting the display mode in an automatic mode of the above-mentioned display device may include the following steps: monitoring the brightness of ambient light in real time; comparing the brightness of ambient light with the first preset threshold value and the second preset threshold value; and adjusting the display mode of the display device to be the night mode if the brightness value of ambient light is lower than the first preset threshold value; or adjusting the display mode of the display device to be the daytime mode if the brightness value of ambient light is higher than the second preset threshold value. The control method for the display device provided by the embodiment of the disclosure will be further described in details below.

The control method for the display device provided by the embodiment of the disclosure may be performed in such a process that, if the display mode is set to automatic adjusting, light from the environment in which the display device is located is monitored in real time by the light detecting device. For example, the brightness of the ambient light detected by the light detecting device is converted into a voltage value according to a correspondence relationship between brightness and voltage value.

The correspondence relationship between brightness and voltage is detected by the following steps: providing a screen with a gray scale; measuring the brightness of the screen; measuring a voltage value of a brightness sensor for the brightness of the screen by a light sensor; and determining the correspondence relationship between the brightness value and the voltage value. For example, the screen may be a white screen, or may be a red screen, a green screen, or the like single color screen.

The method to find the correspondence relationship between brightness and voltage will be further described with a VG871 image display device providing screens with different brightness hereafter. A screen with a gray scales is provided by the VG871 image display device. The brightness of the screen displayed by the VG871 image display device is measured by a display color analyzer 210, and the value of the voltage output by the light sensor is measured by a multimeter, so that the correspondence relationship between the voltage and the brightness can be obtained. The relationship between the voltage and the brightness is shown in FIG. 3. The brightness of the display screen detected by the light sensor has a linear relationship with the value of the voltage converted by the light sensor. That is, the higher the brightness value is, the higher the voltage value output by the light sensor is.

The display device body compares a preset threshold value (the first preset threshold value or the second preset threshold value) with information on the ambient brightness, and then the display mode of the display device is adjusted based on the result of comparison. For example, when the brightness value of the ambient light is lower than the first preset threshold value (e.g., 4 nit, corresponding to a voltage less than 0.2 V), the display mode of the display device is adjusted to be the night mode; when the brightness value of the ambient light is higher than the second threshold (e.g. 16 nit, corresponding to a voltage of 0.6V), the display mode of the display device is adjusted to be the daytime mode. If the brightness value of ambient light is in a range between the first preset threshold value and the second preset threshold value, the current display mode is unchanged.

In order to further prevent automatic adjustment of the display mode of the display device provided by the embodiment of the disclosure from being influenced by a momentary change in the ambient light caused by the user's improper operation, the control method for the display device further includes the step of comparing a duration of the changed brightness value with a preset time value. For example, if the duration of the changed brightness value is less than the preset time value, the current display mode remains unchanged; otherwise, it is changed. For example, the preset time value can be one minute.

To sum up, embodiments of the disclosure provide a display device for adjusting a display mode automatically, a television set and a control method thereof. A display mode of the display device may be selected to be a daytime mode when a user is watching with sufficient light; the display mode of the display device may be selected to be a night mode when the user is watching in dark. The display mode and a brightness of backlight may be adjusted according to a change of ambient light detected by a light detecting device. The embodiments of the disclosure protect users' eyes, so that the users can watch TV at any time without eye fatigue. Eye fatigue and eye damages in dark may be reduced as much as possible by changing the brightness of the backlight as well as the display mode of the TV. It not only reduces the user's error operations, but also improves the user experience.

What are described above is related to the illustrative embodiments of the disclosure only and not limitative to the scope of the disclosure; the scope of the disclosure is defined by the accompanying claims.

The present application claims priority of China Patent application No. 201510406014.8 filed on Jul. 10, 2015, the content of which is incorporated in its entirety by reference herein as part of the present application.

What is claimed is:

1. A display device, comprising a display device body and a light detecting device fixed to the display device body;
wherein the light detecting device is configured to detect ambient brightness and send information on the ambient brightness to the display device body, and
the display device body is configured to compare a first preset threshold value with the information on the ambient brightness and adjust a display mode of the display device to be a first display mode.

2. The display device of claim 1, wherein the display device body is further configured to compare a second preset threshold value with the information on the ambient brightness and adjust the display mode of the display device to be a second display mode.

3. The display device of claim 2, wherein the display device body comprises a memory and a processor, the memory stores the first preset threshold, and the processor is configured to compare the first preset threshold value with the information on the ambient brightness and adjust the display mode of the display device to be the first display mode.

4. The display device of claim 3, wherein the memory further stores the second preset threshold, and the processor is further configured to compare the second preset threshold value with the information on the ambient brightness and adjust the display mode of the display device to be the second display mode.

5. The display device of claim 1, further comprising a front glass plane, wherein the light detecting device is disposed behind the front glass plane of the display device.

6. The display device of claim 5, wherein the light detecting device is disposed at a corner of the front glass plane of the display device.

7. The display device of claim 1, wherein the first display mode and second display mode comprise a night mode and a daytime mode respectively or comprise a daytime mode and a night mode.

8. The display device of claim 1, wherein the light detecting device is configured to detect ambient brightness in real time.

9. A television set comprising the display device, wherein the display device comprises a display device body and a light detecting device fixed to the display device body; the light detecting device is configured to detect ambient brightness and send information on the ambient brightness to the display device body, and the display device body is configured to compare a first preset threshold value with the information on the ambient brightness and adjust a display mode of the display device to be a first display mode.

10. The television set of claim 9, wherein the display device body is further configured to compare a second preset threshold value with the information on the ambient brightness and adjust the display mode of the display device to be a second display mode.

11. The television set of claim 10, wherein the first display mode and second display mode comprise a night mode and a daytime mode respectively or comprise a daytime mode and a night mode.

12. A control method for a display device, comprising:
monitoring brightness of ambient light;
comparing the brightness of the ambient light with a first preset threshold value; and
adjusting a display mode of the display device to be a first display mode if a brightness value of the ambient light is lower than the first preset threshold value.

13. The control method for a display device of claim 12, further comprising:
comparing the brightness of the ambient light with a second preset threshold value;
adjusting the display mode of the display device to be a second mode if the brightness value of the ambient light is higher than the second preset threshold value.

14. The control method for a display device of claim 12, further comprising:
converting the brightness value of ambient light into a voltage value according to a correspondence relationship between brightness and voltage.

15. The control method for a display device of claim 14, wherein a process of obtaining the correspondence relationship between brightness and voltage comprises:
providing a screen with a gray scale;
measuring brightness of the screen;
measuring a voltage value of for the brightness of the screen by a light sensor; and
determining a correspondence relationship between the brightness value and the voltage value.

16. The control method for a display device of claim 12, wherein the screen is a white screen.

17. The control method for a display device of claim 12, wherein the first preset threshold value is four.

18. The control method for a display device of claim 13, wherein the second preset threshold value is 16

19. The control method for a display device of claim 12, further comprising:
comparing a duration of the changed brightness value with a preset time value.

20. The control method for a display device of claim 19, wherein,
if the duration of the changed brightness value is less than the preset time value, a display mode of the display device remains unchanged, otherwise the display mode of the display device is changed.
